(19) United States
(12) Patent Application Publication
(10) Pub. No.: US 2026/0221890 A1
(43) Pub. Date: Jul. 30, 2026

(54) VOLTAGE REGULATOR MODULE PHASE REDUNDANCY THROUGH THROTTLING

(71) Applicant: INTERNATIONAL BUSINESS MACHINES CORPORATION, ARMONK, NY (US)

(72) Inventors: Justin E. Henspeter, Georgetown, TX (US); Eric Jason Fluhr, Leander, TX (US); Gregory Scott Still, Releigh, NC (US); Eric Marz, Williston, VT (US)

(21) Appl. No.: 19/040,463

(22) Filed: Jan. 29, 2025

(51) Int. Cl. H02M 5/04

(52) U.S. Cl. CPC H02M 5/04

(57) ABSTRACT

Described are techniques for Voltage Regulator Module (VRM) phase redundancy. The techniques include detecting a failed phase of a plurality of phases in a VRM. The techniques further include throttling current delivered by remaining operational phases of the plurality of phases until a normal maximum amperage divided by two less than the plurality of phases is less than a maximum per phase current.

### BACKGROUND

The present disclosure relates to computational hardware, and, more specifically, to voltage regulator modules (VRMs).

A VRM can refer to a type of buck converter that provides microprocessors and/or chipsets with an appropriate supply voltage. VRMs can also be referred to as Processor Power Modules (PPMs). VRMs can receive voltage at a first level and subsequently supply voltages at a lower level that is required by the connected devices (e.g., microprocessors, chipsets, etc.), thereby enabling devices with different supply voltage requirements to be mounted on a same motherboard, server, computer, or the like.

### SUMMARY

In some aspects, the techniques described herein relate to a computer-implemented method that comprises detecting a failed phase of a plurality of phases in a Voltage Regulator Module (VRM). The computer-implemented method further comprises throttling current delivered by remaining operational phases of the plurality of phases until a normal maximum amperage divided by two less than the plurality of phases is less than a maximum per phase current.

Additional aspects of the present disclosure are directed to systems and computer program products configured to perform the method described above.

The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system including a server, a Voltage Regulator Module (VRM), and a controller, in accordance with some embodiments of the present disclosure.

FIG. 2A illustrates a block diagram of a VRM with four phases at a first time, in accordance with some embodiments of the present disclosure.

FIG. 2B illustrates a block diagram of the VRM with four phases at a second time and including a failed phase, in accordance with some embodiments of the present disclosure.

FIG. 3A illustrates a block diagram of a VRM with three phases at a first time, in accordance with some embodiments of the present disclosure.

FIG. 3B illustrates a block diagram of the VRM with three phases at a second time and including a failed phase, in accordance with some embodiments of the present disclosure.

FIG. 4A illustrates a block diagram of a VRM with eight phases at a first time, in accordance with some embodiments of the present disclosure.

FIG. 4B illustrates a block diagram of the VRM with eight phases at a second time and including a failed phase, in accordance with some embodiments of the present disclosure.

FIG. 5 illustrates a flowchart of an example method for providing VRM phase redundancy by throttling current, in accordance with some embodiments of the present disclosure.

FIG. 6A illustrates a flowchart of an example method for a current throttling determination, in accordance with some embodiments of the present disclosure.

FIG. 6B illustrates a flowchart of an example method for de-throttling current, in accordance with some embodiments of the present disclosure.

FIG. 7A illustrates a flowchart of an example method for current throttling in response to multiple failed phases in a VRM, in accordance with some embodiments of the present disclosure.

FIG. 7B illustrates a flowchart of an example method for downloading, deploying, metering usage, and invoicing VRM phase redundancy code, in accordance with some embodiments of the present disclosure.

FIG. 8 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward computational hardware, and, more specifically, to voltage regulator modules (VRMs). While not limited to such applications, embodiments of the present disclosure may be better understood in light of the aforementioned context.

Various non-limiting aspects of the present disclosure are described in the following. Clause1: a computer-implemented method comprising detecting a failed phase of a plurality of phases in a Voltage Regulator Module (VRM); and throttling current delivered by remaining operational phases of the plurality of phases until a normal maximum amperage divided by two less than the plurality of phases is less than a maximum per phase current. Advantageously, these aspects of the present disclosure provide phase-redundancy to a VRM without the need for dedicated redundant phases, thereby reducing the cost, complexity, and footprint of the VRM while providing phase redundancy.

Clause 2 includes the features of clause 1. In this clause, the computer-implemented method further comprises determining that a second failed phase of the plurality of phases would cause the remaining operational phases to exceed the maximum per phase current by dividing the normal maximum amperage by two less than the plurality of phases; and determining that a result of the dividing is greater than the maximum per phase current. Advantageously, these aspects of the present disclosure determine a throttled normal maximum amperage that prevents an overcurrent condition from a subsequent phase failure.

Clause 3 includes the features of any one of clauses 1 to 2. In this clause, the VRM does not have any redundant phases in the plurality of phases. Advantageously, these aspects of the present disclosure provide phase redundancy via current throttling rather than by physical redundant phases, thereby saving cost, complexity, and space in VRM designs.

Clause 4 includes the features of any one of clauses1 to 3. In this clause, the computer-implemented method further comprises detecting a new phase that replaces the failed phase in the plurality of phases; and de-throttling the current delivered by the plurality of phases. Advantageously, these aspects of the present disclosure allow for deferred replacement of the failed phase and subsequent resetting of the current to a de-throttled level responsive to replacement of the failed phase.

Clause 5 includes the features of any one of clauses 1 to 4. In this clause, the computer-implemented method further comprises detecting a second failed phase of the plurality of phases; and wherein the remaining operational phases remain functional at the throttled current that is less than the maximum per phase current for respective phases of the remaining operational phases. Advantageously, these aspects of the present disclosure provide phase-redundancy to a VRM experiencing multiple phase failures without the need for dedicated redundant phases, thereby reducing the cost, complexity, and footprint of the VRM while providing phase redundancy.

Clause 6 includes the features of any one of clauses 1 to 5. In this clause, the computer-implemented method further comprises detecting a second failed phase of the plurality of phases; and further throttling the current delivered by the remaining operational phases until the normal maximum amperage divided by three less than the plurality of phases is less than the maximum per phase current. Advantageously, these aspects of the present disclosure provide phase-redundancy to a VRM experiencing multiple phase failures (e.g., down to a single remaining operational phase) without the need for dedicated redundant phases, thereby reducing the cost, complexity, and footprint of the VRM while providing phase redundancy.

Clause 7 includes the features of any one of clauses 1 to 6. In this clause, the VRM is a pluggable VRM. Advantageously, these aspects of the present disclosure provide phase-redundancy as an ad-hoc, modular solution to existing servers and/or other computer-architectures.

Clause 8 is a system comprising one or more processors and one or more computer-readable storage media storing program instructions which, when executed by the one or more processors, are configured to cause the one or more processors to perform a method according to any one of clauses 1 to 7. These aspects of the present disclosure realize the same advantages as previously discussed with respect to clauses 1 to 7.

Clause 9 is a computer program product comprising one or more computer readable storage media, and program instructions collectively stored on the one or more computer readable storage media, the program instructions comprising instructions configured to cause one or more processors to perform a method according to any one of clauses 1 to 7. These aspects of the present disclosure realize the same advantages as previously discussed with respect to clauses 1 to 7.

Clause 10 is a server comprising a pluggable Voltage Regulator Module (VRM) that comprises a plurality of phases, none of which are redundant; a processor; and a computer-readable storage medium storing program instructions executable by the processor, wherein the program instructions are configured to cause the processor to perform a method comprising: detecting a failed phase of the plurality of phases; determining that a second failed phase of the plurality of phases would cause remaining operational phases to exceed a maximum per phase current by: dividing a normal maximum amperage by two less than the plurality of phases; and determining that a result of the dividing is greater than the maximum per phase current; throttling current delivered by the remaining operational phases of the plurality of phases until a normal maximum amperage divided by two less than the plurality of phases is less than a maximum per phase current; detecting a second failed phase of the plurality of phases; and further throttling the current delivered by the remaining operational phases until the normal maximum amperage divided by three less than the plurality of phases is less than the maximum per phase current.

Advantageously, these aspects of the present disclosure provide phase-redundancy to a VRM without the need for dedicated redundant phases, thereby reducing the cost, complexity, and footprint of the VRM while providing phase redundancy. Additionally, these aspects of the present disclosure determine a throttled normal maximum amperage that prevents an overcurrent condition from a subsequent phase failure. Furthermore, these aspects of the present disclosure provide phase redundancy via current throttling rather than by physical redundant phases, thereby saving cost, complexity, and space in VRM designs. Finally, these aspects of the present disclosure provide phase-redundancy to a VRM experiencing multiple phase failures (e.g., down to a single remaining operational phase) without the need for dedicated redundant phases, thereby reducing the cost, complexity, and footprint of the VRM while providing phase redundancy.

Embedded or pluggable VRMs can be used in servers, computers, and/or other computational systems in order to deliver voltage and current to subsystems (e.g., processors, chips, etc.). VRMs can be designed to be phase redundant in order to realize a high degree of availability. Phase redundancy allows for one or more phases (e.g., power stages) to fail, isolates the one or more failed phases from adjacent (parallel) phases, and allows the system to continue to operate without fault and/or a meaningful loss of availability. VRM designs incorporating phase redundancy first consider the minimum number of phases (N) required to support a given application under worst case loading conditions. An additional number of “redundant” phases (e.g., 1, 2, etc.) are then added to the design for resilience (e.g., N+2, where N = 4 means a total of 6 phases in parallel). In a VRM designed with N+2 phases, 2 phases can be lost and the VRM is still capable of supporting the worst-case loading requirements. However, the total number of phases necessary to realize phase redundancy at a system level can become burdensome as the number of distinct output voltages required by various subsystems increases. For example, in applications having multiple processor rails required for a single processor module, the number of additional phases necessary to maintain N+2 redundancy is costly and difficult to physically package in the limited area available (e.g., one N+2 regulator equates to 2 redundant phases while eight N+2 regulators equate to 16 redundant phases).

Aspects of the present disclosure are directed to overcoming the cost, packaging, and complexity challenges that arise from traditional VRMs with redundant phases. According to aspects of the present disclosure, a VRM can be designed without any redundant phases, and processor chip performance can be adjusted (e.g., throttled) to a predetermined load level in response to any phase failure(s) in the VRM (e.g., a transition from N to N-1 phases, a transition from N-1 phases to N-2 phases, etc.). Absent the throttling mechanism envisioned by aspects of the present disclosure, a transition from N to N-1 phases could lead to an overcurrent condition on the remaining phases and a subsequent system crash. In contrast, aspects of the present disclosure allow for deferred replacement of any failed phase(s) through throttling of the chip(s) associated with the failed phase(s) of the VRM, thereby realizing the benefits of (i) cost savings relative to VRMs with redundant phases, (ii) smaller packaging footprint relative to VRMs with redundant phases, (iii) robust against system crashes by avoiding overcurrent conditions, and/or (iv) providing availability/redundancy to connected subsystems via throttling rather than via redundant phases.

Future processors will require an increase in the number of individually controllable voltage rails available at a system level. The ability to physically package the traditionally required N+2 redundant phases in a VRM is becoming prohibitive to system design (e.g., space, cost, complexity, etc.). By reducing the total number of phases to only those required to meet worst case system operating conditions at N and enabling performance (e.g., current) throttling at a chip-level based on an N-1 state (or other further reduction in phase count), the total number of required VRM phases in a system that includes any form of redundancy can be significantly reduced. Aspects of the present disclosure thereby reduce overall system cost, improve system availability, and simplify system design.

Aspects of the present disclosure function by monitoring the number of active VRM phases associated with a specific chip. When a specified phase count threshold is detected (e.g., a reduction in phases due to a failed phase), performance of the chip associated with the given VRM output is throttled to a predetermined load level to accommodate the remaining phase count’s maximum supportable current capability. The current delivered by the VRM can be further throttled (e.g., by adjusting performance and/or current draw at the associated chip(s)) to predetermined load levels in the event of additional phase faults/failures. In some embodiments, aspects of the present disclosure throttle performance to predetermined load levels up to and including the maximum allowable phase current for a single phase remaining operational phase.

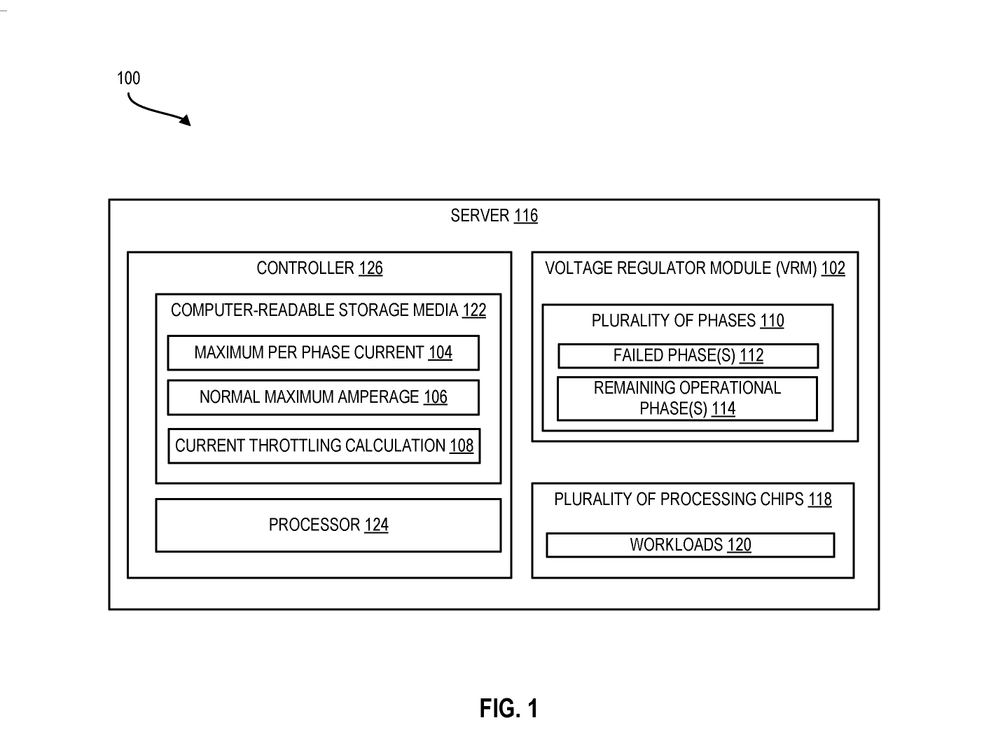

Referring now to the figures, FIG. 1 illustrates a block diagram of an example system 100 including a server 116, a Voltage Regulator Module (VRM) 102, and a controller 126, in accordance with some embodiments of the present disclosure. Server 116 can include a plurality of processing chips 118 running one or more workloads 120. In some embodiments, server 116 can instead refer to a lower-level hardware architecture such as a motherboard or server subsystem. The plurality of processing chips 118 can refer to any electrical and/or electronic component in server 116 that consumes electricity for the purposes of performing tasks, computations, operations, and/or other processing, storage, and/or networking related to execution of workloads 120. Workloads 120 can refer to tasks, computations, operations, and/or other processing, storing, and/or transmitting tasks related to implementation of software, firmware, middleware, and/or other code.

VRM 102 can be a pluggable VRM or a VRM 102 embedded into the hardware architecture of an associated server 116. VRM 102 can include a plurality of phases 110 including failed phases 112 and/or remaining operational phases 114. VRM 102 can deliver electricity to the plurality of processing chips 118 enabling execution of the workloads 120.

Controller 126 can include a computer-readable storage media 122 storing a maximum per phase current 104, a normal maximum amperage 106, and a current throttling calculation 108. Maximum per phase current 104 can be a preconfigured or user-defined maximum acceptable current per phase of the plurality of phases 110 of the VRM 102. The normal maximum amperage 106 can be a preconfigured or user-defined value, and it can refer to the high end of the expected load the VRM 102 is expected to provide to the plurality of processing chips 118. As will be appreciated by one skilled in the art, when there are no failed phases 112, the per phase current is the normal maximum amperage 106 (or a number less than the normal maximum amperage 106) divided by the plurality of phases 110, where the result of the dividing is less than the maximum per phase current 104.

The current throttling calculation 108 can receive as input the maximum per phase current 104, the normal maximum amperage 106, the failed phases 112, and/or the remaining operational phases 114 to determine an appropriate throttling of current (e.g., by throttling the normal maximum amperage 106) to maintain service to the plurality of processing chips 118 following a phase failure and while avoiding an overcurrent condition at the VRM 102 and/or the plurality of processing chips 118. More specifically, the current throttling calculation 108 can determine an adjusted (e.g., throttled) normal maximum amperage 106 so that one less than the remaining operational phases 114 does not exceed the maximum per phase current 104. In this way, the VRM 102 can absorb a phase failure without resulting in an overcurrent condition that compromises availability of the plurality of processing chips 118 running the workloads 120.

The controller 126 can further include a processor 124 capable of implementing the current throttling calculation 108. The controller 126 can reside anywhere within, or communicatively coupled to, the server 116. In some embodiments, the controller 126 can reside within the plurality of processing chips 118, for example.

FIG. 1 is illustrative and should not be construed as limiting. For example, the plurality of phases 110 can be communicatively coupled to the VRM 102 rather than incorporated into the VRM 102. As another example, the VRM 102 can be associated with a plurality of servers 116 rather than a single server 116. Additionally, the plurality of processing chips 118 need not reside within a single server 116 but can instead be spread across a plurality of servers 116. Additionally, the computer-readable storage media 122 can instead be a single computer-readable storage medium and/or the processor 124 can instead be a plurality of processors 124. Finally, the computer-readable storage media 122 and/or the processor 124 can reside outside of the server 116 and be communicatively coupled to the server 116 such that the VRM 102 and/or the plurality of processing chips 118 can receive and implement instructions from the processor 124 reading code from the computer-readable storage media 122.

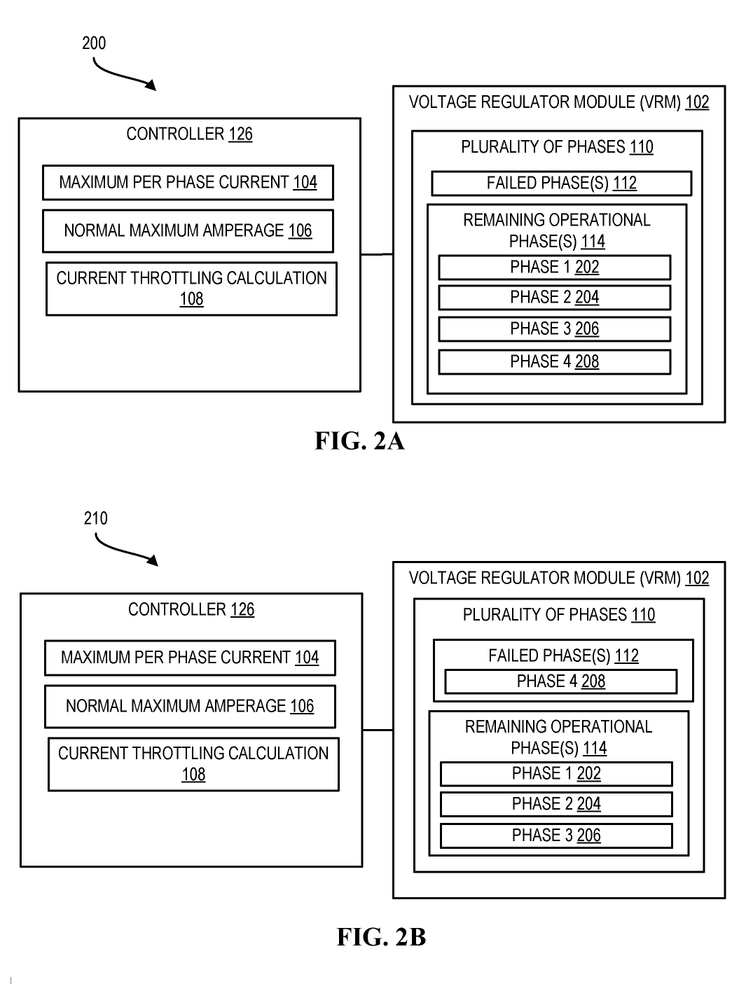

FIG. 2A illustrates a block diagram of a VRM 102 with four phases (e.g., phase 1202, phase 2 204, phase 3 206, and phase 4 208) at a first time 200, in accordance with some embodiments of the present disclosure. Aspects of the present disclosure can define a maximum per phase current 104 (e.g., a maximum supported per phase under any failover scenario) and a normal maximum amperage 106 under normal operating conditions. These two values can be used to determine a maximum support of the remaining operational phases 114. In this example, assume the maximum per phase current 104 is 50 Amps (A) and the normal maximum amperage 106 is 130 A (e.g., 32.5 A/phase (ph)). Further assume that in a four-phase system operating at 130 A normal maximum amperage 106, each phase delivers 32.5 A.

FIG. 2B illustrates a block diagram of the VRM 102 with four phases at a second time 210 and including a failed phase 112 (e.g., phase 4208), in accordance with some embodiments of the present disclosure. In the event that a single phase (e.g., phase 4 208) is lost due to failure, the three remaining phases (e.g., phase 1202, phase 2 204, and phase 3 206) are required to support 43.3 A/ph. Although the VRM output can continue to support 130 A indefinitely at this phase count, if an additional phase is lost without a throttle in the processor performance, the remaining 2 phases would be required to support 130A at 65 A/ph (i.e., exceeding the highest supported current of 50 A). Therefore, in this scenario the controller 126 can be configured to adjust the normal maximum amperage 106 to 100 A upon losing the first phase so that a subsequent phase failure would not result in an overcurrent condition. This adjustment can be realized by the plurality of processing chips (e.g., plurality of processing chips 118 of FIG. 1) drawing a throttled level of current from the VRM 102. This ensures that in the event of an additional phase fault, the VRM output will continue to support the maximum (throttled) current. A call home can take place before, during, and/or after the current throttling. Additionally, the controller 126 can continue adjusting the normal maximum amperage 106 to 50 A (e.g., in response to additional phase failures), allowing for a sole remaining operational phase.

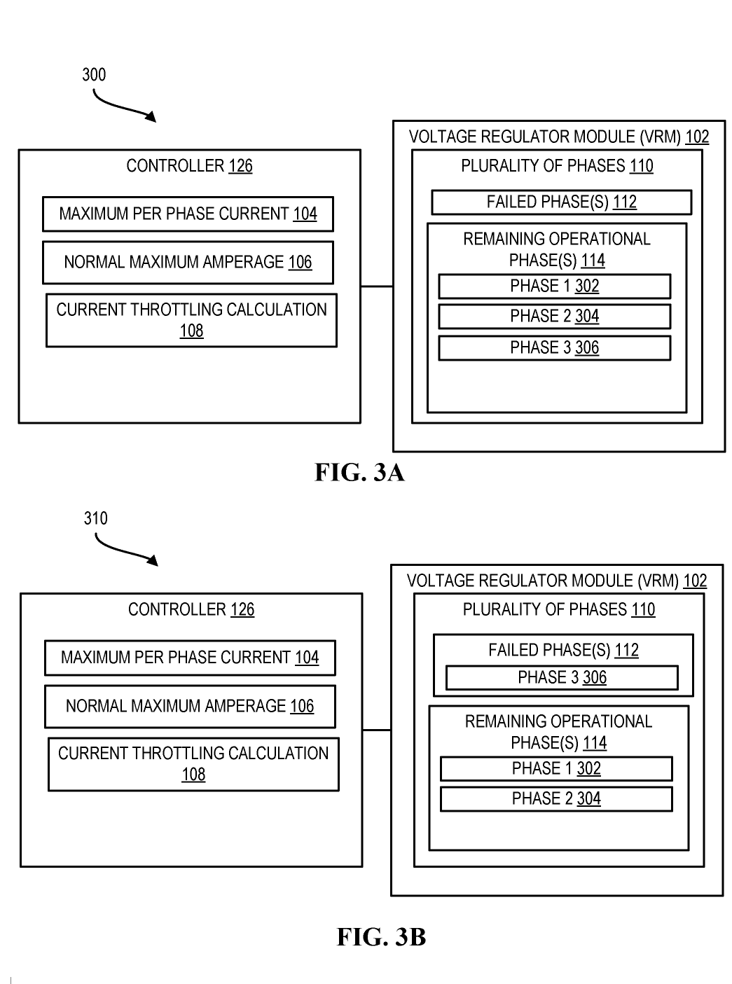

FIG. 3A illustrates a block diagram of a VRM 102 with three phases (e.g., phase 1 302, phase 2 304, and phase 3 306) at a first time 300, in accordance with some embodiments of the present disclosure. In this example, assume the maximum per phase current 104 is 50 A and the normal maximum amperage 106 is 100 A (e.g., 33.3 A/ph). In the three-phase system shown in FIG. 3A operating at 100 A max load, each phase delivers 33.3A.

FIG. 3B illustrates a block diagram of the VRM 102 with three phases at a second time 310 and including a failed phase 112 (e.g., phase 3306), in accordance with some embodiments of the present disclosure. If a single phase is lost (e.g., phase 3306), the remaining two phases (e.g., phase 1302 and phase 2 304) are required to support 50 A/ph. Processor performance (e.g., plurality of processing chips 118 of FIG. 1) should be throttled such that if an additional phase fails (e.g., leaving a single operational phase), the maximum per phase current 104 is not exceeded. In this case, the controller 126 can adjust the normal maximum amperage 106 from 100 A to 50 A and the associated processors (e.g., plurality of processing chips 118) can throttle the current drawn from the VRM 102 in response to losing the first phase (e.g., phase 3306). Call home can take place before, during, and/or after the current throttling, however, even if an additional phase is lost, the final phase will continue to deliver current (e.g., at 50A) without a crash or further throttling of performance.

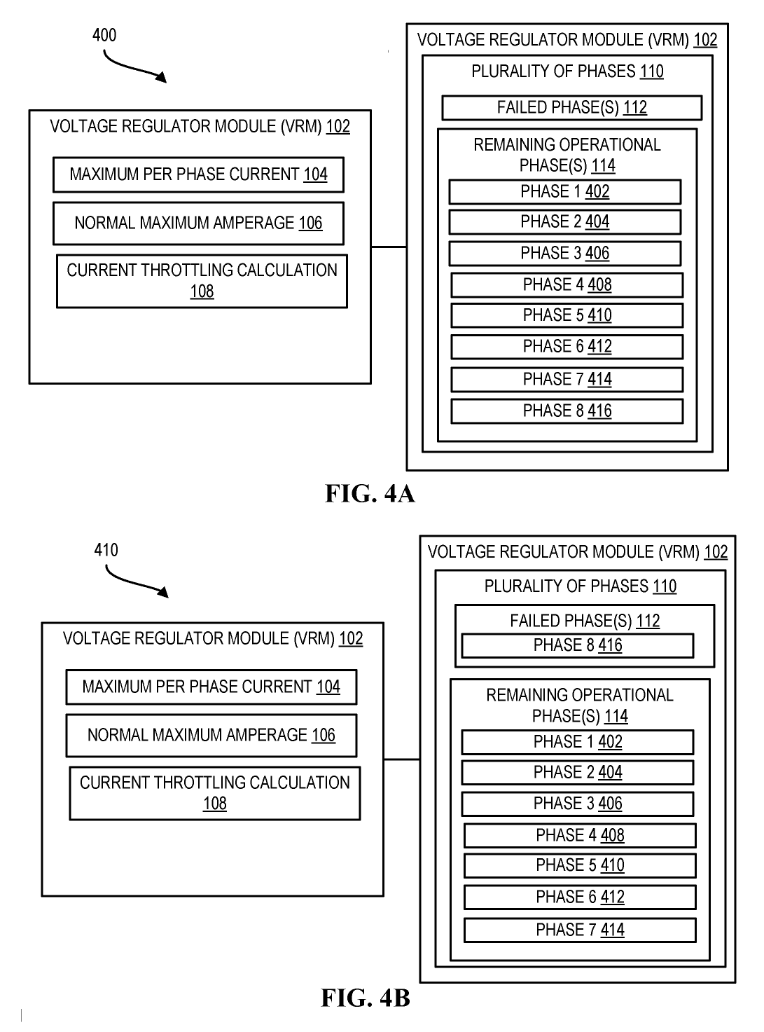

FIG. 4A illustrates a block diagram of a VRM 102 with eight phases (e.g., phase 1402, phase 2 404, phase 3 406, phase 4 408, phase 5 410, phase 6 412, phase 7 414, and phase 8 416) at a first time 400, in accordance with some embodiments of the present disclosure. In this example, assume the maximum per phase current 104 is 50 A and the normal maximum amperage 106 is 200 A (e.g., 25 A/ph). In an eight-phase system operating at 200 A max load, each phase delivers 25 A.

FIG. 4B illustrates a block diagram of the VRM 102 with eight phases at a second time 410 and including a failed phase (e.g., phase 8416), in accordance with some embodiments of the present disclosure. With the loss of one phase, the seven remaining phases are required to temporarily support 29 A/ph. In this case, the VRM can continue to run with 7 phases at 200 A (29 A/ph) since if another phase is lost, each phase would be required to support 33.3 A/ph (which is still below the 50 A maximum per phase current 104). However, once there are three failed phases 112 and five remaining operational phases 114, the controller 126 can adjust the normal maximum amperage 106 and the associated processors can throttle their performance (since losing an additional phase would result in 50 A/phase). If necessary, throttling can continue until only one phase (operating at the maximum per phase current 104 of 50 A) is reached.

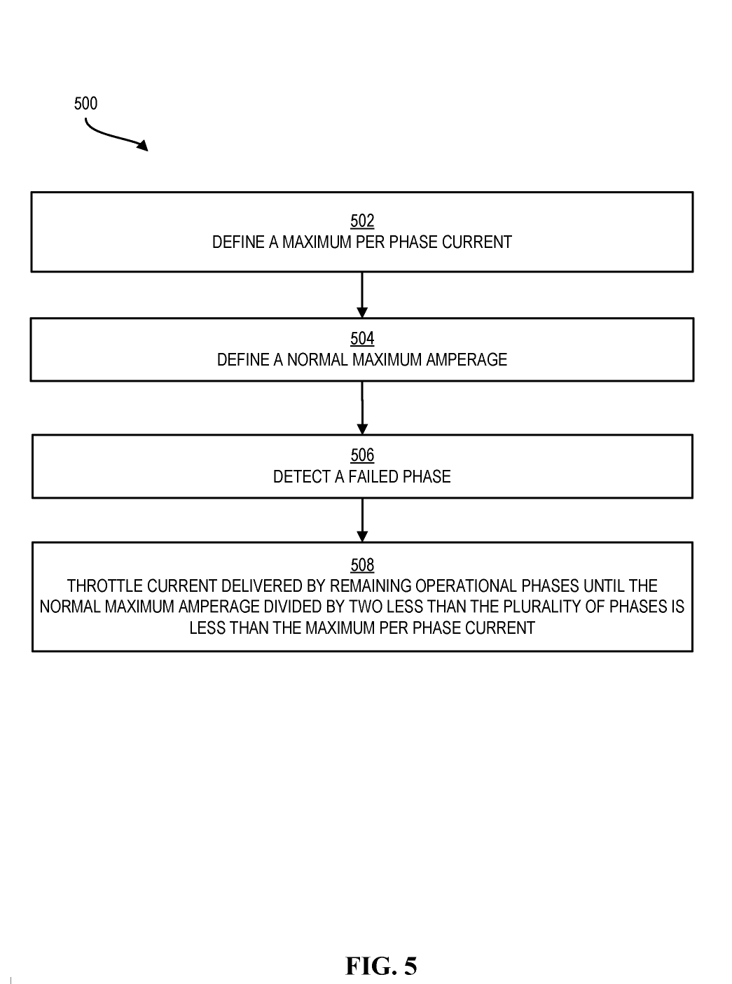

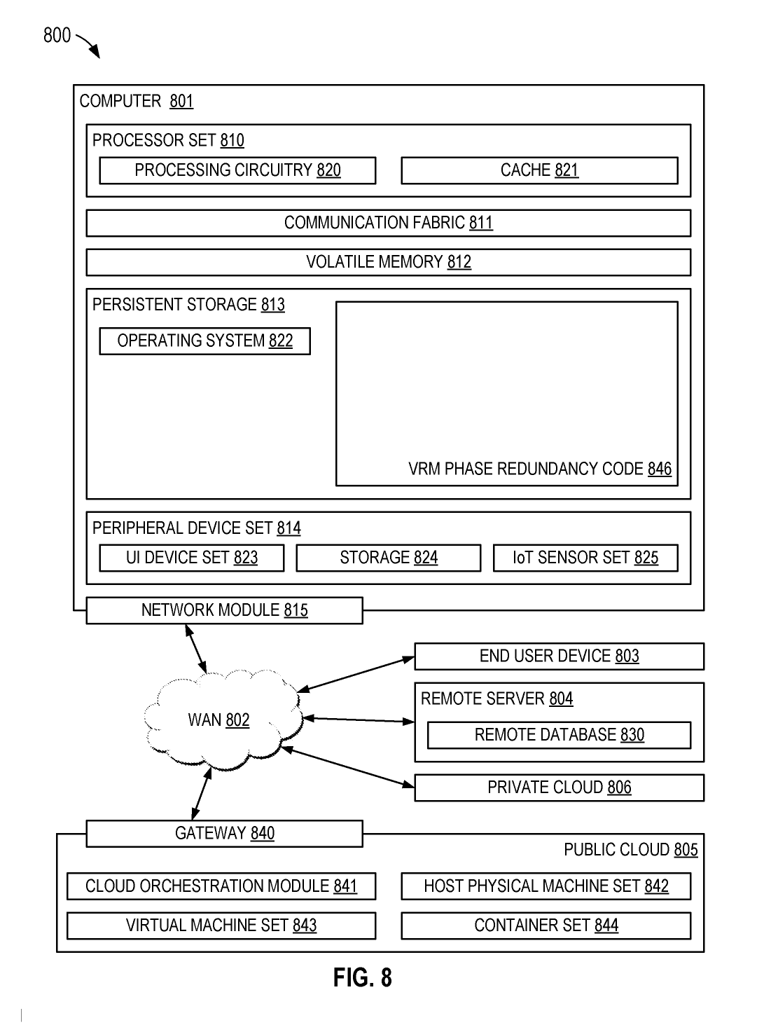

FIG. 5 illustrates a flowchart of an example method 500 for providing VRM phase redundancy by throttling current, in accordance with some embodiments of the present disclosure. The method 500 can be implemented by a processor (e.g., processor 124 of FIG. 1), a computer (e.g., computer 801 of FIG. 8), a controller (e.g., controller 126 of FIG. 1), or any other combination of hardware and/or software.

Operation 502 includes defining a maximum per phase current 104. Operation 504 includes defining a normal maximum amperage 106. The maximum per phase current 104 and the normal maximum amperage 106 can be user-defined values and/or preconfigured values (e.g., based on manufacturer and/or client specifications).

Operation 506 includes detecting a failed phase 112 of a plurality of phases 110 associated with a VRM 102. A failed phase 112 can be detected based on feedback from the VRM 102, a server 116 coupled to the VRM 102, and/or a processing chip 118 coupled to the failed phase 112.

Operation 508 includes throttling current delivered by remaining operational phases 114 of the plurality of phases 110 until the normal maximum amperage 106 divided by two less than the plurality of phases 110 is less than the maximum per phase current 104. In some embodiments, operation 508 throttles current delivered by the remaining operational phases 114 based on adjustments to workloads 120 by the plurality of processing chips 118. In this way, the method 500 can ensure any subsequent phase failure does not result in an overcurrent condition that compromises availability of the plurality of processing chips 118 executing the workloads 120.

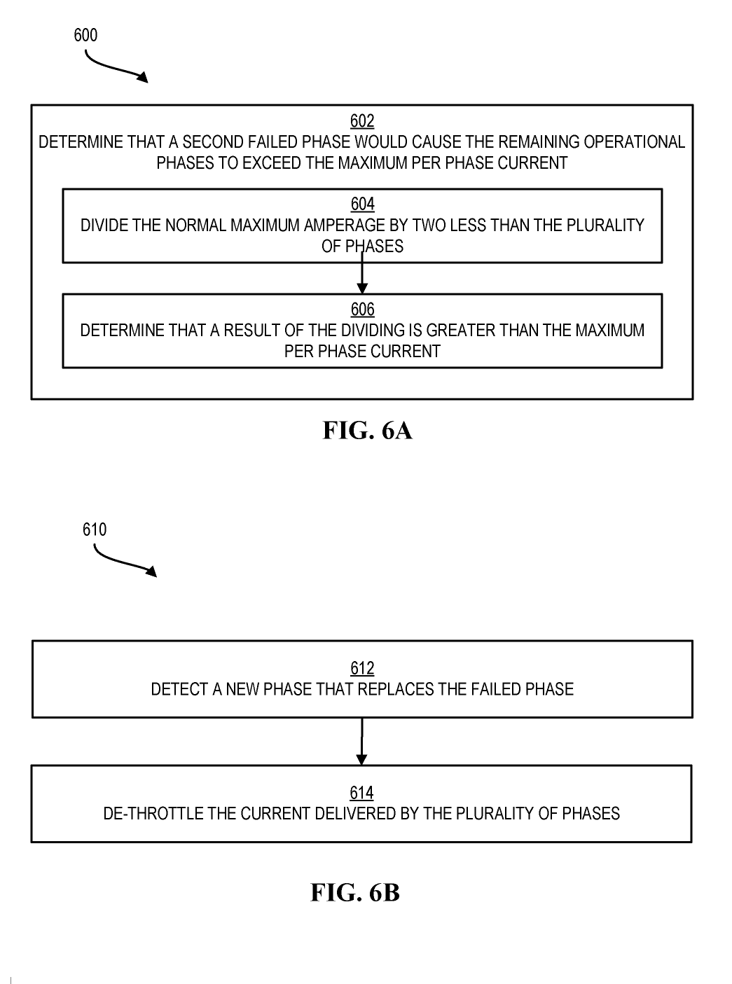

FIG. 6A illustrates a flowchart of an example method 600 for a current throttling determination, in accordance with some embodiments of the present disclosure. The method 600 can be implemented by a processor (e.g., processor 124 of FIG. 1), a computer (e.g., computer 801 of FIG. 8), a controller (e.g., controller 126 of FIG. 1), or any other combination of hardware and/or software. In some embodiments, the method 600 occurs between operations 506 and 508 of the method 500 of FIG. 5.

Operation 602 includes determining that a second failed phase would cause the remaining operational phases 114 to exceed the maximum per phase current 104. Operation 602 can be made up of two sub-operations. Namely, sub-operation 604 and sub-operation 606. Sub-operation 604 includes dividing the normal maximum amperage 106 by two less than the plurality of phases 110 (or one less than the remaining operational phases 114 in cases where there are multiple failed phases 112). Sub-operation 606 includes determining that a result of the dividing is greater than the maximum per phase current 104.

In this way, the method 600 detects when any subsequent phase failure could result in an overcurrent condition that may compromise availability of the plurality of processing chips 118 executing the workloads 120.

FIG. 6B illustrates a flowchart of an example method 610 for de-throttling current, in accordance with some embodiments of the present disclosure. The method 610 can be implemented by a processor (e.g., processor 124 of FIG. 1), a computer (e.g., computer 801 of FIG. 8), a controller (e.g., controller 126 of FIG. 1), or any other combination of hardware and/or software. In some embodiments, the method 610 occurs after operation 508 of the method 500 of FIG. 5.

Operation 612 includes detecting a new phase that replaces the failed phase 112. The new phase can be detected based on feedback from the VRM 102, a server 116 coupled to the VRM 102, and/or a processing chip 118 coupled to the failed phase 112.

Operation 614 includes de-throttling the current delivered by the plurality of phases 110. In other words, operation 614 can increase the normal maximum amperage 106 by the appropriate amount given the addition of the new phase while maintaining all of the plurality of phases 110 at less than the maximum per phase current 104. In some embodiments, operation 614 is realized by adjustments to workloads 120 by the plurality of processing chips 118.

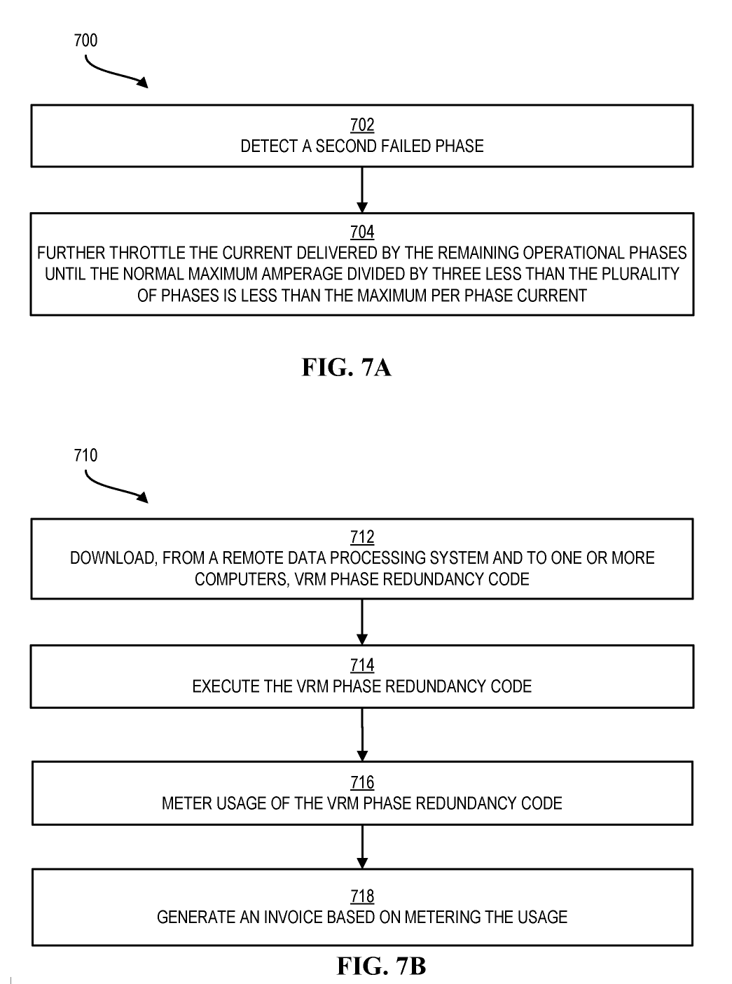

FIG. 7A illustrates a flowchart of an example method 700 for current throttling in response to multiple failed phases 112 in a VRM 102, in accordance with some embodiments of the present disclosure. The method 700 can be implemented by a processor (e.g., processor 124 of FIG. 1), a computer (e.g., computer 801 of FIG. 8), a controller (e.g., controller 126 of FIG. 1), or any other combination of hardware and/or software. In some embodiments, the method 700 occurs after operation 508 of the method 500 of FIG. 5.

Operation 702 includes detecting a second failed phase 112. The second failed phase 112 can be detected based on feedback from the VRM 102, a server 116 coupled to the VRM 102, and/or a processing chip 118 coupled to the failed phase 112.

Operation 704 includes further throttling the current delivered by the remaining operational phases 114 until the normal maximum amperage 106 divided by three less than the plurality of phases 110 (or by one less than the remaining operational phases 114) is less than the maximum per phase current 104. In some embodiments, operation 704 further throttles the current delivered by the remaining operational phases 114 by adjusting processing performance on workloads 120 by the plurality of processing chips 118. In this way, the method 700 can ensure any subsequent phase failure does not result in an overcurrent condition that compromises availability of the plurality of processing chips 118 executing the workloads 120.

FIG. 7B illustrates a flowchart of an example method for downloading, deploying, metering usage, and invoicing VRM phase redundancy code 846, in accordance with some embodiments of the present disclosure. The method 710 can be implemented by a processor (e.g., processor 124 of FIG. 1), a computer (e.g., computer 801 of FIG. 8), a controller (e.g., controller 126 of FIG. 1), or any other combination of hardware and/or software. In some embodiments, the method 710 occurs before, during, and/or after any of the aforementioned methods.

Operation 712 includes downloading, from a remote data processing system and to one or more computers (e.g., server 116 of FIG. 1, controller 126 of FIG. 1, computer 801 of FIG. 8, etc.) VRM phase redundancy code 846. Operation 714 includes executing the VRM phase redundancy code 846. The executing can include performing any of the methods and/or functionalities discussed herein. Operation 716 includes metering usage of the VRM phase redundancy code 846. Usage can be metered by, for example, an amount of time the VRM phase redundancy code 846 is used, a number of servers, controller, processing chips, and/or VRMs implementing the VRM phase redundancy code 846, an amount of resources consumed by implementing the VRM phase redundancy code 846, a number of current throttling and/or de-throttling operations implemented by execution of the VRM phase redundancy code 846, a cumulative number of phases monitored by the VRM phase redundancy code 846, and the like. Operation 718 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 illustrates a block diagram of an example computing environment, in accordance with some embodiments of the present disclosure. Computing environment 800 contains an example of an environment for the execution of at least some of the computer code involved in performing the inventive methods, such as VRM phase redundancy code 846. In addition to VRM phase redundancy code 846, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and VRM phase redundancy code 846, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located "off chip." In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in VRM phase redundancy code 846 in persistent storage 813.

Communication fabric 811 is the signal conduction paths that allow the various components of computer 801 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in VRM phase redundancy code 846 typically includes at least some of the computer code involved in performing the inventive methods.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

Cloud computing services and/or microservices (not separately shown in FIG. 8): private clouds 806 and public clouds 805 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers’ code, transmit the proxy server code, and then install the proxy server code on the proxy computer. The process software will be transmitted to the proxy server, and then it will be stored on the proxy server.

Embodiments of the present disclosure can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client’s operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
detecting a failed phase of a plurality of phases in a Voltage Regulator Module (VRM); and
throttling current delivered by remaining operational phases of the plurality of phases until a normal maximum amperage divided by two less than the plurality of phases is less than a maximum per phase current.

2. The computer-implemented method of claim 1, further comprising:
determining that a second failed phase of the plurality of phases would cause the remaining operational phases to exceed the maximum per phase current by:
dividing the normal maximum amperage by two less than the plurality of phases; and
determining that a result of the dividing is greater than the maximum per phase current.

3. The computer-implemented method of claim 1, wherein the VRM does not have any redundant phases in the plurality of phases.

4. The computer-implemented method of claim 1, further comprising:
detecting a new phase that replaces the failed phase in the plurality of phases; and
de-throttling the current delivered by the plurality of phases.

5. The computer-implemented method of claim 1, further comprising:
detecting a second failed phase of the plurality of phases; and
wherein the remaining operational phases remain functional at the throttled current that is less than the maximum per phase current for respective phases of the remaining operational phases.

6. The computer-implemented method of claim 1, further comprising:
detecting a second failed phase of the plurality of phases; and
further throttling the current delivered by the remaining operational phases until the normal maximum amperage divided by three less than the plurality of phases is less than the maximum per phase current.

7. The computer-implemented method of claim 1, wherein the VRM is a pluggable VRM.

8. A system comprising:
a processor; and
a computer-readable storage medium storing program instructions executable by the processor, wherein the program instructions are configured to cause the processor to perform a method comprising:
detecting a failed phase of a plurality of phases in a Voltage Regulator Module (VRM); and
throttling current delivered by remaining operational phases of the plurality of phases until a normal maximum amperage divided by two less than the plurality of phases is less than a maximum per phase current.

9. The system of claim 8, wherein the method further comprises:
determining that a second failed phase of the plurality of phases would cause the remaining operational phases to exceed the maximum per phase current by:
dividing the normal maximum amperage by two less than the plurality of phases; and
determining that a result of the dividing is greater than the maximum per phase current.

10. The system of claim 8, wherein the VRM does not have any redundant phases in the plurality of phases.

11. The system of claim 8, wherein the method further comprises:
detecting a new phase that replaces the failed phase in the plurality of phases; and
de-throttling the current delivered by the plurality of phases.

12. The system of claim 8, wherein the method further comprises:
detecting a second failed phase of the plurality of phases; and
wherein the remaining operational phases remain functional at the throttled current that is less than the maximum per phase current for respective phases of the remaining operational phases.

13. The system of claim 8, wherein the method further comprises:
detecting a second failed phase of the plurality of phases; and
further throttling the current delivered by the remaining operational phases until the normal maximum amperage divided by three less than the plurality of phases is less than the maximum per phase current.

14. The system of claim 8, wherein the VRM is a pluggable VRM.

15. A computer program product comprising one or more computer readable storage media, and program instructions collectively stored on the one or more computer readable storage media, the program instructions comprising instructions configured to cause one or more processors to perform a method comprising:
detecting a failed phase of a plurality of phases in a Voltage Regulator Module (VRM); and
throttling current delivered by remaining operational phases of the plurality of phases until a normal maximum amperage divided by two less than the plurality of phases is less than a maximum per phase current.

16. The computer program product of claim 15, wherein the method further comprises:
determining that a second failed phase of the plurality of phases would cause the remaining operational phases to exceed the maximum per phase current by:
dividing the normal maximum amperage by two less than the plurality of phases; and
determining that a result of the dividing is greater than the maximum per phase current.

17. The computer program product of claim 15, wherein the VRM does not have any redundant phases in the plurality of phases.

18. The computer program product of claim 15, wherein the method further comprises:
detecting a second failed phase of the plurality of phases; and
wherein the remaining operational phases remain functional at the throttled current that is less than the maximum per phase current for respective phases of the remaining operational phases.

19. The computer program product of claim 15, wherein the method further comprises:
detecting a second failed phase of the plurality of phases; and
further throttling the current delivered by the remaining operational phases until the normal maximum amperage divided by three less than the plurality of phases is less than the maximum per phase current.

20. The computer program product of claim 15, wherein the VRM is a pluggable VRM.
